(19) United States
(12) Patent Application Publication
(10) Pub. No.: US 2010/0309393 A1
(43) Pub. Date: Dec. 9, 2010

(54) ILLUMINATING DEVICE, DISPLAY DEVICE, AND TELEVISION RECEIVER

(75) Inventor: Takahiro Yoshikawa, Osaka-shi (JP)

Correspondence Address: SHARP KABUSHIKI KAISHA;C/O KEATING & BENNETT, LLP, 1800 Alexander Bell Drive, SUITE 200, Reston, VA, 20191, US

(73) Assignee: SHARP KABUSHIKI KAISHA, Osaka-shi, Osaka (JP)

(21) Appl. No.: 12/864,662

(22) PCT Filed: Oct. 1, 2008
(86) PCT No.: PCT/JP2008/067834

§ 371 Date: Jul. 27, 2010

(30) Foreign Application Priority Data
Feb. 22, 2008 (JP) 2008-041905

(51) Int. Cl. H04N 3/14; F21S 4/00; H05B 37/02

(52) U.S. Cl. 348/790; 362/225; 315/312; 348/E05.096

(57) ABSTRACT

An illuminating device (3) provided with a plurality of hot cathode fluorescent tubes (discharge tubes) (20a to 20f) includes: sockets (21a to 21f) to be connected electrically to respective electrode portions (20A) of the plurality of the hot cathode fluorescent tubes (20a to 20f); and a wiring member (22) that is connected electrically to a plurality of the sockets (21a to 21f) so as to integrate wirings (22b1 to 22b12) of the plurality of the hot cathode fluorescent tubes (20a to 20f).

### TECHNICAL FIELD

The present invention relates to an illuminating device, in particular, an illuminating device using discharge tubes such as a hot cathode fluorescent tube, a display device using the same, and a television receiver.

### BACKGROUND ART

Recently, in a household television receiver, for example, a display device provided with a liquid crystal panel as a flat display portion with a number of features such as thinness and a light weight as compared with a conventional Broun tube, as typified by a liquid crystal display device, is becoming a mainstream. Such a liquid crystal display device includes an illuminating device that emits light and a liquid crystal panel that displays a desired image by playing a role of a shutter with respect to light from a light source provided in the illuminating device. The television receiver displays information such as characters and images contained in video signals of a television broadcast on a display surface of the liquid crystal panel.

Further, the above-described illuminating device is classified roughly into a direct type and an edge-light type depending on the arrangement of the light source with respect to the liquid crystal panel. A liquid crystal display device provided with a liquid crystal panel of 20 inches or more generally uses the direct type illuminating device that can achieve an increase in brightness and size more easily than the edge-light type illuminating device. More specifically, in the direct type illuminating device, a plurality of light sources are arranged on the rear side (non-display surface) of the liquid crystal panel. Since the light sources can be arranged right on the reverse side of the liquid crystal panel, it is possible to use a number of the light sources. Thus, the direct type illuminating device can achieve high brightness easily and is suitable for an increase in brightness and size. Further, the direct type illuminating device has a hollow structure and hence is light-weight even when enlarged. This also allows the direct type illuminating device to be suitable for an increase in brightness and size. As the light sources, discharge tubes such as a cold cathode fluorescent tube and a hot cathode fluorescent tube are used.

As described in JP 2000-149648 A, for example, the conventional illuminating device as described above includes as light sources a plurality of hot cathode fluorescent tubes, each having sockets at its both ends, such that the hot cathode fluorescent tubes are connected to a lighting drive circuit via cables connected to the sockets. In this conventional illuminating device, it is proposed to drive the hot cathode fluorescent tubes by way of high-frequency lighting by the lighting drive circuit.

### DISCLOSURE OF INVENTION

### Problem to be Solved by the Invention

Meanwhile, the conventional illuminating device as described above is required to have an increased number of discharge tubes such as a hot cathode fluorescent tube so as to achieve a large-screen liquid crystal panel, an increase in brightness, and the like.

However, when the conventional illuminating device has an increased number of discharge tubes, it is necessary to provide wirings such as cables for the respective discharge tubes, which inevitably leads to an increase in the number of components. Further, when the conventional illuminating device, which requires wirings for the respective discharge tubes, has an increased number of discharge tubes, it takes considerable time and labor to perform a wiring process for extending the wirings, for example, and the assembling operability decreases significantly.

In view of the above-described problems, it is an object of the present invention to provide an illuminating device that can achieve a reduction in the number of components and improve the assembling operability even when an increased number of discharge tubes are provided, a display device using the same, and a television receiver.

### Means for Solving Problem

In order to achieve the above-described object, an illuminating device according to the present invention is provided with a plurality of discharge tubes. The illuminating device includes: sockets to be connected electrically to respective electrode portions of the plurality of the discharge tubes; and a wiring member that is connected electrically to a plurality of the sockets so as to integrate wirings of the plurality of the discharge tubes.

The illuminating device configured as described above includes the wiring member that is connected electrically to the plurality of the sockets so as to integrate the wirings of the plurality of the discharge tubes. Thus, unlike the conventional example, even when an increased number of the discharge tubes are provided, it is possible to eliminate the need for providing the wirings for the respective discharge tubes. As a result, it is possible to provide the illuminating device that can achieve a reduction in the number of components and improve the assembling operability even when an increased number of the discharge tubes are provided.

Further, in the above-described illuminating device, the wiring member and each of the plurality of the sockets may be connected electrically so as to be movable with respect to each other.

In this case, even when a thermal expansion difference develops between the wiring member and each of the plurality of the sockets, it is possible to prevent adverse effects on the wiring member and each of the sockets due to the thermal expansion difference, while maintaining the electrical connection therebetween.

Further, it is preferable that the above-described illuminating device further includes a housing that accommodates the plurality of the discharge tubes. Preferably, the plurality of the sockets are provided inside the housing and are connected electrically with the plurality of the respective discharge tubes, and the wiring member includes, inside the housing, socket connecting portions to be connected electrically to the plurality of the respective sockets and a wiring terminal portion for leading out the wirings of the plurality of the discharge tubes to the outside of the housing.

In this case, it is possible to provide the illuminating device with excellent assembling operability and a small number of components easily, as compared with the case where the sockets and the like are provided outside the housing.

Further, in the above-described illuminating device, the wiring member preferably is provided so as to be movable with respect to the housing.

In this case, even when a thermal expansion difference develops between the wiring member and the housing, it is possible to prevent adverse effects on the wiring member and the housing due to the thermal expansion difference.

Further, in the above-described illuminating device, each of the plurality of the sockets may be fixed to the housing.

In this case, the discharge tubes can be accommodated in the housing stably.

Further, in the above-described illuminating device, the wiring member may include a feedback signal line for performing feedback control of the discharge tubes.

In this case, the discharge tubes can be lit suitably.

Further, in the above-described illuminating device, the wiring member may include ground wirings to be grounded.

In this case, it is possible to prevent external noise from entering the wiring member.

Further, in the above-described illuminating device, in the wiring member, wiring portions to be connected to the respective electrode portions of the plurality of the discharge tubes preferably are provided so as to be insulated from each other.

In this case, it is possible to supply each of the plurality of the discharge tubes with different power, making it possible to light each of the discharge tubes more suitably.

Further, in the above-described illuminating device, in the wiring member, a plurality of the socket connecting portions preferably are provided linearly.

In this case, the wiring member can be made compact easily.

Further, in the above-described illuminating device, the wiring member may be formed of a printed circuit board.

In this case, the wiring member has an excellent handling property, and thus the assembling operation of the illuminating device can be simplified easily.

Further, in the above-described illuminating device, each of the discharge tubes may be a hot cathode fluorescent tube.

In this case, each of the discharge tubes has excellent light conversion efficiency, and thus it is possible to provide the illuminating device with excellent light emission efficiency easily.

Further, it is preferable that the above-described illuminating device further includes a lighting drive circuit that lights the plurality of the discharge tubes. Preferably, the wiring member and the lighting drive circuit are connected electrically to each other by using one multi-core cable having a plurality of core wires that are provided for the respective wirings of the plurality of the discharge tubes.

In this case, it is possible to provide easily the illuminating device with a small number of components in which the wiring member and the lighting drive circuit can be connected easily.

Further, in the above-described illuminating device, each of the sockets may be fixed by a holder.

In this case, each of the sockets can be fixed stably.

A display device according to the present invention uses any one of the above-described illuminating devices.

A television receiver according to the present invention uses the above-described display device.

The display device and the television receiver configured as described above use the illuminating device that can achieve a reduction in the number of components and improve the assembling operability even when an increased number of the discharge tubes are provided. Thus, it is possible to provide easily the display device and the television receiver that can be manufactured easily and can achieve an increase in screen size and brightness easily.

### EFFECTS OF THE INVENTION

According to the present invention, it is possible to provide an illuminating device that can achieve a reduction in the number of components and improve the assembling operability even when an increased number of discharge tubes are provided, a display device using the same, and a television receiver.

### BRIEF DESCRIPTION OF DRAWINGS

FIG. 1 is an exploded perspective view illustrating a television receiver and a liquid crystal display device according to an embodiment of the present invention.

FIG. 2 is a schematic cross-sectional view illustrating an illuminating device and the liquid crystal display device according to the embodiment of the present invention.

FIG. 3 is a view illustrating a configuration of main portions of the illuminating device.

FIG. 4 is a plan view showing a configuration of a wiring member shown in FIG. 3.

FIG. 5A is a side view showing the wiring member and a multi-core cable shown in FIG. 3, FIG. 5B is a plan view showing a configuration of a wiring terminal portion of the wiring member, and FIG. 5C is a plan view showing a configuration of a terminal portion of the multi-core cable.

FIGS. 6A to 6C are views illustrating a process of assembling the liquid crystal display device.

FIGS. 7A to 7C are views illustrating a process of assembling the liquid crystal display device.

FIG. 8 is a view illustrating a process of assembling the liquid crystal display device.

FIG. 9 is a view illustrating a process of assembling the liquid crystal display device.

### DESCRIPTION OF THE INVENTION

Hereinafter, a preferred embodiment of an illuminating device, a display device using the same, and a television receiver according to the present invention will be described with reference to the drawings. It should be noted that the following description is directed to the case where the present invention is applied to a transmission type liquid crystal display device by way of example. Further, the size and size ratio of the constituent members in each figure do not exactly reflect those of actual constituent members.

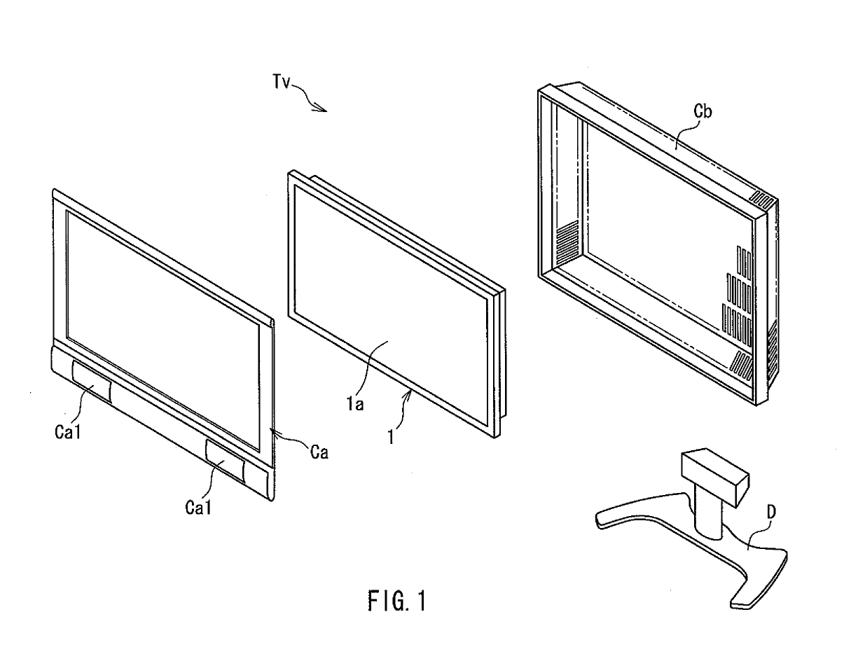

FIG. 1 is an exploded perspective view illustrating a television receiver and a liquid crystal display device according to an embodiment of the present invention. In the figure, a television receiver Tv of the present embodiment is provided with a liquid crystal display device 1 as a display device and is configured to be capable of receiving a television broadcast by means of an antenna, a cable (not shown), and the like. The liquid crystal display device 1, housed within a front cabinet Ca and a back cabinet Cb, is set upright by using a stand D. Further, in the television receiver Tv, a display surface 1a of the liquid crystal display device 1 is configured to be visible via the front cabinet Ca. The liquid crystal display device 1 is supported by the stand D in such a manner that this display surface 1a is parallel to the direction of gravity (vertical direction).

Further, in the television receiver Tv, images corresponding to video signals of a television broadcast received by a TV tuner portion not shown are displayed on the display surface 1a, while audio is reproduced and output from speakers Ca1 mounted on the front cabinet Ca. It should be noted that a number of air holes are formed on the back cabinet Cb so as to appropriately release heat generated in an illuminating device, a power source, and the like.

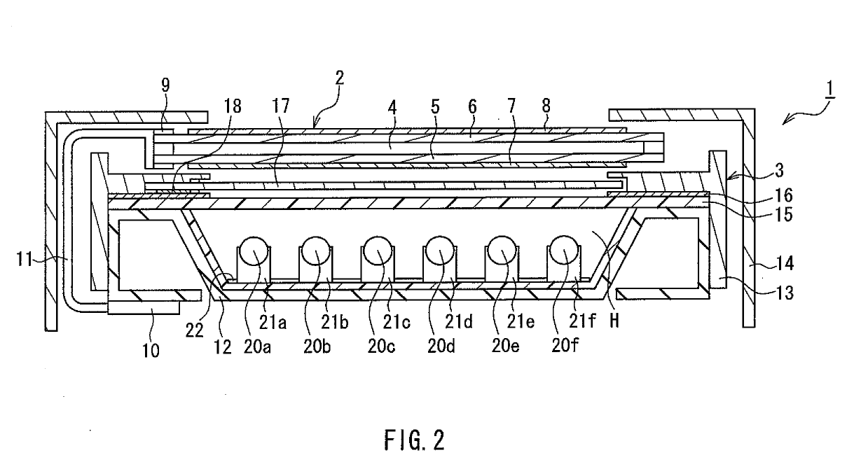

Next, an illuminating device and the liquid crystal display device 1 according to the present embodiment will be described specifically with reference to FIG. 2.

FIG. 2 is a schematic cross-sectional view illustrating the illuminating device and the liquid crystal display device according to the embodiment of the present invention. In FIG. 2, the liquid crystal display device 1 of the present embodiment includes a liquid crystal panel 2 as a display portion that is located with the upper side in FIG. 2 defined as a viewing side (display surface side), and an illuminating device 3 of the present invention that is arranged on the non-display surface side of the liquid crystal panel 2 (lower side in FIG. 2) and generates illumination light to illuminate the liquid crystal panel 2.

The liquid crystal panel 2 includes a liquid crystal layer 4, a pair of transparent substrates 5 and 6 between which the liquid crystal layer 4 is sandwiched, and polarizing plates 7 and 8 provided respectively on outer surfaces of the transparent substrates 5 and 6. Further, the liquid crystal panel 2 includes a driver 9 for driving the liquid crystal panel 2, and a drive circuit 10 connected to the driver 9 via a flexible printed board 11, so that the liquid crystal layer 4 can be driven on a pixel basis. In the liquid crystal panel 2, a polarization state of the illumination light incident through the polarizing plate 7 is modulated by the liquid crystal layer 4, and an amount of light passing through the polarizing plate 8 is controlled, whereby a desired image is displayed.

The illuminating device 3 includes a bottomed chassis 12 with the upper side in FIG. 2 (liquid crystal panel 2 side) opened, and a frame 13 placed on the liquid crystal panel 2 side of the chassis 12. The chassis 12 forms a housing that accommodates hot cathode fluorescent tubes (discharge tubes), which will be described later. Further, the chassis 12 and the frame 13 are made of a metal or a synthetic resin and are sandwiched by a bezel 14 having an L-shape in cross section with the liquid crystal panel 2 located above the frame 13. Thus, the illuminating device 3 is assembled with the liquid crystal panel 2, so that they are integrated into the transmission type liquid crystal display device 1 in which the illumination light from the illuminating device 3 is incident on the liquid crystal panel 2.

Further, the illuminating device 3 includes a diffusion plate 15 located so as to cover the opening of the chassis 12, an optical sheet 17 located above the diffusion plate 15 on the liquid crystal penal 2 side, and a reflecting sheet 19 provided on an inner surface of the chassis 12. In the illuminating device 3, a plurality of discharge tubes, e.g., six hot cathode fluorescent tubes 20a, 20b, 20c, 20d, 20e, and 20f (hereinafter, collectively referred to as “20”), are arranged in parallel with each other above the reflecting sheet 19. These hot cathode fluorescent tubes 20 are spaced uniformly at regular intervals (pitches) in a direction (horizontal direction in FIG. 2) perpendicular to the longitudinal direction thereof, and light from each of the hot cathode fluorescent tubes 20 is output as the illumination light from a light-emitting surface of the illuminating device 3 that is arranged so as to be opposed to the liquid crystal panel 2.

The diffusion plate 15, which is made of, for example, a rectangular-shaped synthetic resin or glass material having a thickness of about 2 mm, diffuses the light (containing light reflected from the reflecting sheet 19) from the hot cathode fluorescent tubes 20 and outputs the light to the optical sheet 17 side. Further, four sides of the diffusion plate 15 are placed on a frame-shaped surface of the chassis 12 provided on the upper side thereof, and the diffusion plate 15 is incorporated in the illuminating device 3 while being sandwiched between the frame-shaped surface of the chassis 12 and an inner surface of the frame 13 with a pressure member 16 capable of being deformed elastically interposed therebetween. Further, the diffusion plate 15 is supported substantially at its center by a transparent support member (not shown) located on the reflective sheet 19, whereby the diffusion plate 15 is prevented from being bent toward the inside of the chassis 12.

The diffusion plate 15 is held so as to be movable between the chassis 12 and the pressure member 16. Even when the diffusion plate 15 is expanded/contracted (deformed plastically) due to the influence of heat caused by heat generation in the hot cathode fluorescent tubes 20, temperature rise inside the chassis 12, and the like, the plastic deformation is absorbed by the elastic deformation of the pressure member 16, whereby a decrease in diffusion of the light from the hot cathode fluorescent tubes 20 is minimized. Further, it is preferred to use the diffusion plate 15 made of a glass material, which is more resistant to heat as compared with a synthetic resin, since warpage, yellowing, thermal deformation, and the like caused by the influence of heat are unlikely to occur.

The optical sheet 17 includes a diffusion sheet formed of, for example, a synthetic resin film having a thickness of about 0.5 mm and is configured to diffuse the illumination light to the liquid crystal panel 2 appropriately so as to enhance the display quality on the display surface of the liquid crystal panel 2. Further, on the optical sheet 17, known optical sheet materials such as a prism sheet and a polarizing sheet for enhancing the display quality on the display surface of the liquid crystal panel 2, for example, are laminated appropriately, if required. The optical sheet 17 is configured to convert the light output from the diffusion plate 15 into plane-shaped light having a predetermined brightness (for example, 10000 cd/m²) or more and having an almost uniform brightness and to allow the converted light to be incident on the liquid crystal panel 2 side as the illumination light. Besides the above description, for example, an optical member such as a diffusion sheet for adjusting the viewing angle of the liquid crystal panel 2 may be laminated appropriately above (on the display surface side of) the liquid crystal panel 2.

Further, the optical sheet 17 is provided with a protrusion protruding to the left side in FIG. 2 at the center on the left end side in FIG. 2, which is to be the upper side during actual use of the liquid crystal display device 1, for example. In the optical sheet 17, only the protrusion is sandwiched between the inner surface of the frame 13 and the pressure member 16 with an elastic material 18 interposed therebetween, and the optical sheet 17 is incorporated in the illuminating device 3 so as to be capable of expanding/contracting. Thus, the optical sheet 17 is configured in such a manner that, even when the expansion/contraction (plastic) deformation occurs due to the influence of heat caused by heat generation in the hot cathode fluorescent tubes 20 and the like, the optical sheet 17 is capable of expanding/contracting freely with respect to the protrusion, whereby wrinkles, warpage, and the like are minimized in the optical sheet 17. Consequently, in the liquid crystal display device 1, it is possible to minimize degradation in display quality such as non-uniform brightness on the display surface of the liquid crystal panel 2 due to warpage and the like of the optical sheet 17.

The reflecting sheet 19, which is formed of, for example, a thin metal film of aluminum, silver, or the like having a thickness of about 0.2 to 0.5 mm with a high light reflectance, functions as a reflector that reflects the light from the hot cathode fluorescent tubes 20 towards the diffusion plate 15. Thus, in the illuminating device 3, the reflecting sheet 19 can reflect the light emitted from the hot cathode fluorescent tubes 20 to the diffusion plate 15 side efficiently so as to enhance the use efficiency of the light and the brightness in the diffusion plate 15. Besides the above description, instead of the thin metal film, a reflecting sheet material of a synthetic resin may be used, or alternatively, for example, a coating such as a white coating having a high light reflectance may be applied to the inner surface of the chassis 12 so that the inner surface functions as a reflector.

Each of the hot cathode fluorescent tubes 20 is of a straight-tube fluorescent lamp type having a diameter of about 10 to 40 mm. The hot cathode fluorescent tubes 20 are held inside the chassis 12 while being kept at predetermined distances from the diffusion plate 15 and the reflecting sheet 19 by a light source holder not shown. Further, the hot cathode fluorescent tubes 20 are arranged so that the longitudinal direction thereof is parallel to a direction perpendicular to the direction of gravity. This arrangement prevents mercury (vapor) sealed inside each of the hot cathode fluorescent tubes 20 from being concentrated on one end side in the longitudinal direction due to the action of gravity, resulting in significantly improved lamp life.

The hot cathode fluorescent tubes 20a to 20f include electrode portions at both ends thereof, which are connected electrically to sockets 21a, 21b, 21c, 21d, 21e, and 21f (hereinafter, collectively referred to as “21”), respectively. Wirings of the hot cathode fluorescent tubes 20 are led out of the chassis 12 while being integrated by a wiring member 22 as described later. In the illuminating device 3, the hot cathode fluorescent tubes 20 are connected to a lighting drive circuit (inverter circuit), which will be described later, and lit by PWM dimming, for example.

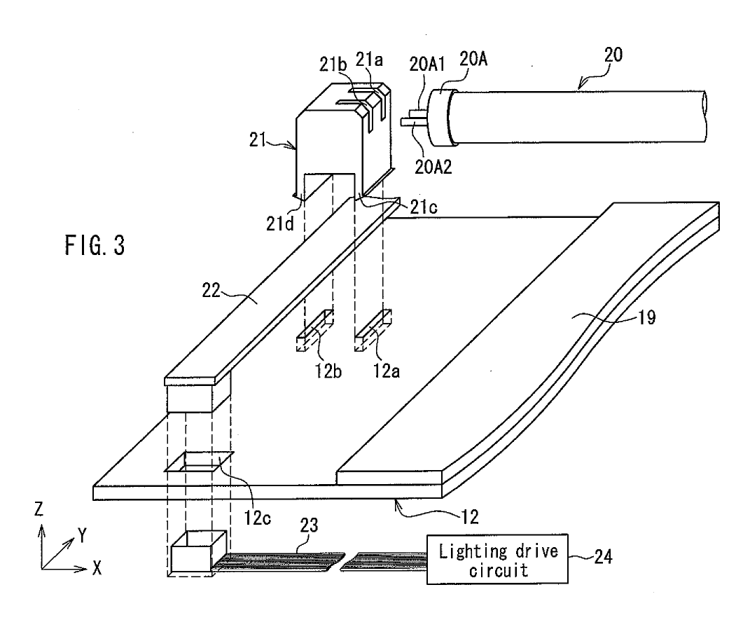

Here, a specific description will be given of a wiring structure in the illuminating device 3 of the present embodiment also with reference to FIGS. 3 to 5A to 5C.

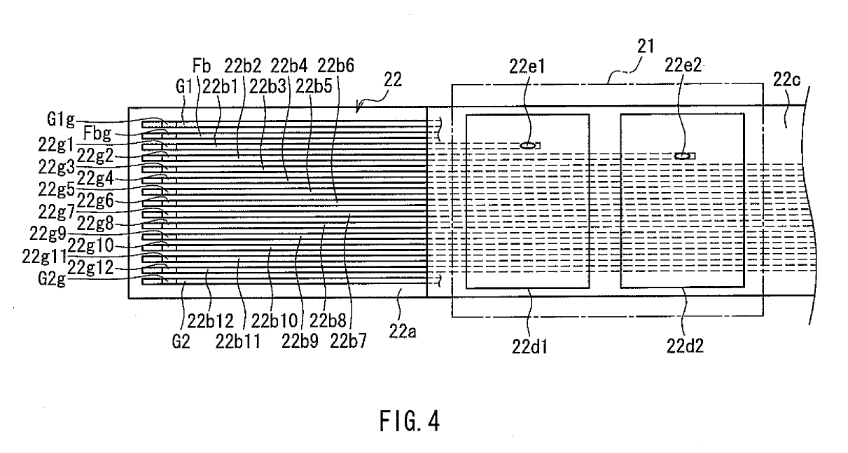

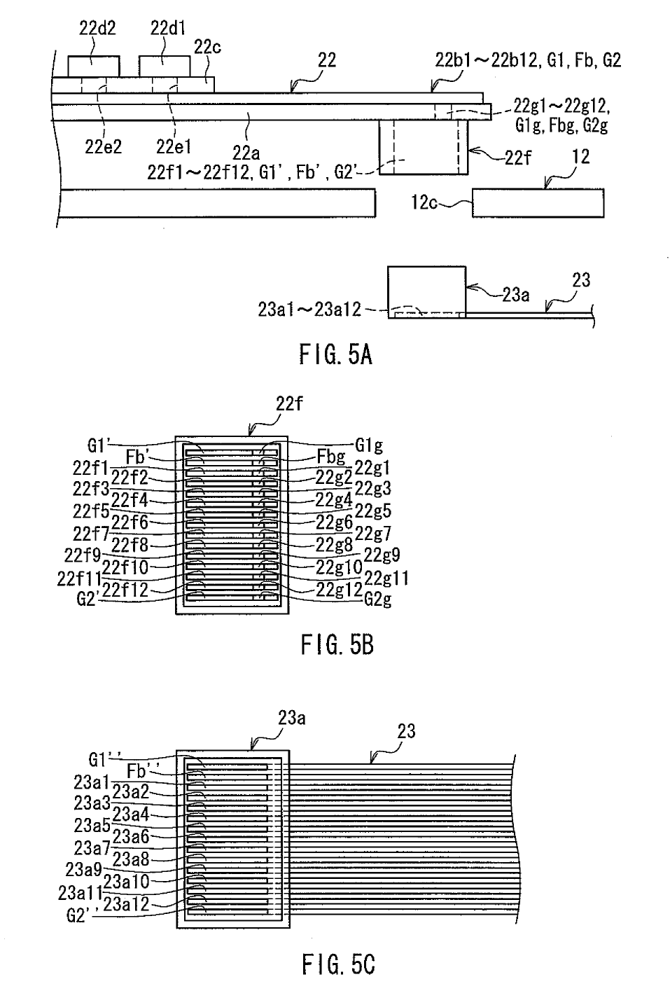

FIG. 3 is a view illustrating a configuration of main portions of the illuminating device. FIG. 4 is a plan view showing a configuration of the wiring member shown in FIG. 3. FIG. 5A is a side view showing the wiring member and a multi-core cable shown in FIG. 3, FIG. 5B is a plan view showing a configuration of a wiring terminal portion of the wiring member, and FIG. 5C is a plan view showing a configuration of a terminal portion of the multi-core cable. It should be noted that FIGS. 3 to 5A to 5C illustrate the wiring structure on one end side of each of the hot cathode fluorescent tubes 20 by way of example, and do not illustrate the wiring structure on the other end side of each of the hot cathode fluorescent tubes 20 that is formed similarly.

As shown in FIG. 3, the socket 21 is connected electrically to an electrode portion 20A of the hot cathode fluorescent tube 20. More specifically, the socket 21 is provided with insertion holes 21a and 21b into which electrode terminals 20A1 and 20A2 provided in the electrode portion 20A are inserted respectively. When the electrode terminals 20A1 and 20A2 are connected electrically to electrodes (not shown) provided inside the respective insertion holes 21a and 21b, the hot cathode fluorescent tube 20 and the socket 21 are connected electrically to each other.

Further, the socket 21 is provided with attachment portions 21c and 21d on the lower side thereof and is fixed to the chassis 12 when the attachment portions 21c and 21d are inserted respectively into attachment holes 12a and 12b formed in the chassis 12. In this manner, since the socket 21 is fixed to the chassis 12 as a housing that accommodates the hot cathode fluorescent tube (discharge tube) 20, the socket 21 enables the hot cathode fluorescent tube 20 to be accommodated in the chassis 21 stably. Further, when the socket 21 is fixed to the chassis 12, the electrodes thereof are connected electrically to the wiring member 22, so that the electrode terminals 20A1 and 20A2 of the hot cathode fluorescent tube 20 are connected electrically to wirings of the wiring member 22 independently of each other (details will be described later).

The wiring member 22 is provided inside the chassis 12 so as to be movable with respect to the chassis 12. More specifically, the wiring member 22 is provided without being fixed to the chassis 12 such that a wiring terminal portion, which will be described later, is connected electrically to a multi-core cable 23 while being inserted into a lead-out hole 12c formed in the chassis 12 to protrude to the outside of the chassis 12.

The socket 21 and the wiring member 22 are provided in a non-effective light-emitting region of the illuminating device 3 inside the chassis 12, so that adverse effects such as non-uniform brightness on the illumination light to be incident on the liquid crystal panel 2 side are minimized. Further, a holder H (FIG. 2) to be mounted on the socket 21 is provided in contact with the socket 21 and the wiring member 22 so as to fix the six sockets 21 and the wiring member 22 inside the chassis 12 integrally. The use of the holder H enables the socket 21 to be fixed to the chassis 21 stably.

The electrode terminals 20A1 and 20A2 are contained in wirings of the hot cathode fluorescent tube (discharge tube) 20. Wirings of the six tubes are integrated by the wiring member 22 and then are connected to one end side of the multi-core cable 23 and further connected electrically to the lighting drive circuit 24 on the other end side of the multi-core cable 23 outside the chassis 12.

More specifically, also with reference to FIGS. 4 and 5A to 5C, the wiring member 22 is formed of a printed circuit board, for example. Namely, the wiring member 22 includes a board main body 22a, twelve wirings 22b1, 22b2, . . . , 22b11, and 22b12 provided on the board main body 22a, and an insulating layer 22c formed so as to cover the wirings 22b1 to 22b12 on the socket 21 side. Further, the wiring member 22 includes a pair of socket connecting portions 22d1 and 22d2 that are provided on the insulating layer 22c for each of the sockets 21. The socket connecting portions 22d1 and 22d2 are connected electrically to the electrodes of the socket 21 and further connected electrically to the respective electrode terminals 20A1 and 20A2 of the hot cathode fluorescent tube 20 via the electrodes inside the chassis 12. Further, as shown in FIG. 4 as an example, the socket connecting portions 22d1 and 22d2 are connected electrically to the wirings 22b1 and 22b2 via respective conducting portions 22e1 and 22e2 in through holes formed in the insulating layer 22c.

The wiring member 22 and each of a plurality of the sockets 21 are connected electrically so as to be movable with respect to each other. Namely, for example, the socket connecting portions 22d1 and 22d2 of the wiring member 22 and the electrodes of the corresponding socket 21 are connected electrically so as to be movable with respect to each other. Thus, even when a thermal expansion difference develops between the wiring member 22 and the plurality of the sockets 21, it is possible to prevent adverse effects on the wiring member 22 and the sockets 21 due to the thermal expansion difference, while maintaining the electrical connection therebetween.

Further, as shown in FIG. 4 as an example, in the wiring member 22, a plurality of the socket connecting portions 22d1 and 22d2 are provided linearly so as to be connected electrically to the plurality of the sockets 21 (FIG. 2) located linearly. Thus, since the plurality of the socket connecting portions 22d1 and 22d2 are provided linearly, the wiring member 22 can be made compact easily.

Further, as shown in FIG. 5A, on the right end side in the figure, the wiring member 22 includes on the lower surface side (opposite to the socket connecting portions 22d1 and 22d2) of the board main body 22a a wiring terminal portion 22f for leading out the wirings of the plurality of the hot cathode fluorescent tubes 20 to the outside of the chassis 12. The wiring terminal portion 22f includes twelve rectangular terminal portions 22f1, 22f2, . . . , 22f11, and 22f12 provided for the respective wirings 22b1 to 22b12. The terminal portions 22f1 to 22f12 are connected electrically to the corresponding wirings 22b1 to 22b12 via respective conducting portions 22g1, 22g2, . . . , 22g11, and 22g12 in the through holes formed in the board main body 22a. Thus, the wiring member 22 can lead out the twelve wirings in total of the six hot cathode fluorescent tubes 20 to the outside of the chassis 12 integrally.

The wirings 22b1 to 22b12, the conducting portions 22g1 to 22g12, and the terminal portions 22f1 to 22f12 of the wiring member 22 are contained in wiring portions to be connected to the respective electrode portions 20A of the plurality of the hot cathode fluorescent tubes (discharge tubes) 20, and the wirings 22b1 to 22b12, the conducting portions 22g1 to 22g12, and the terminal portions 22f1 to 22f12 respectively are provided so as to be insulated from each other. Thus, in the illuminating device 3 of the present embodiment, it is possible to supply each of the plurality of the hot cathode fluorescent tubes 20 with different power, making it possible to light each of the hot cathode fluorescent tubes 20 more suitably.

Further, as shown in FIG. 4, the wiring member 22 includes a feedback signal line Fb for performing feedback control of the hot cathode fluorescent tube 20 above the wiring 22b1. As shown also in FIGS. 5A to 5C, the feedback signal line Fb is connected to a terminal portion Fb′ provided in the wiring terminal portion 22f via a conducting portion Fbg provided in the board main body 22a and is led out to the outside of the chassis 12, similarly to the wirings 22b1 to 22b12. In the illuminating device 3 of the present embodiment, providing the feedback signal line Fb makes it possible to perform feedback control each of the plurality of the hot cathode fluorescent tubes 20, whereby each of the hot cathode fluorescent tubes 20 can be lit suitably.

Besides the above description, for example, the feedback signal line may be provided for each of the six hot cathode fluorescent tubes 20 so as to perform feedback control of each of the hot cathode fluorescent tubes 20.

Further, as shown in FIG. 4, the wiring member 22 includes ground wirings G1 and G2 to be grounded above the feedback signal line Fb and below the wiring 22b12, respectively, so as to surround the wirings 22b1 to 22b12 and the feedback signal line Fb. As shown also in FIGS. 5A to 5C, the ground wirings G1 and G2 respectively are connected to terminal portions G1′ and G2′ provided in the wiring terminal portion 22f via conducting portions G1g and G2g provided in the board main body 22a and are led out to the outside of the chassis 12, similarly to the wirings 22b1 to 22b12. In the illuminating device 3 of the present embodiment, providing the ground wirings G1 and G2 makes it possible to prevent external noise from entering the wiring member 22.

Besides the above description, for example, the ground wiring may be provided for adjacent two wirings among the wirings 22b1 to 22b12, or alternatively, a predetermined ground wiring pattern may be provided on an upper surface or lower surface of the board main body 22a.

The multi-core cable 23 includes a terminal portion 23a to be connected to the wiring terminal portion 22f of the wiring member 22 on the left end side in FIG. 5A. The terminal portion 23a includes core wires 23a1, 23a2, . . . , 23a11, and 23a12 provided for the respective wirings of the six hot cathode fluorescent tubes 20. When the terminal portion 23a is connected to (engaged with) the wiring terminal portion 22f, the core wires 23a1 to 23a12 are connected electrically to the terminal portions 22f1 to 22f12, respectively. Thus, in the illuminating device 3, power from the lighting drive circuit 24 is supplied to each of the hot cathode fluorescent tubes 20 via the multi-core cable 23, the wiring member 22, and the socket 12.

Further, the terminal portion 23a of the multi-core cable 23 includes core wires Fb″, G1″, and G2″ to be connected to the terminal portions Fb′, G1′, and G2′, respectively. When the terminal portion 23a is connected to the wiring terminal portion 22f, the terminal portions Fb′, G1′, and G2′ are connected electrically to the core wires Fb″, G1″, and G2″, respectively.

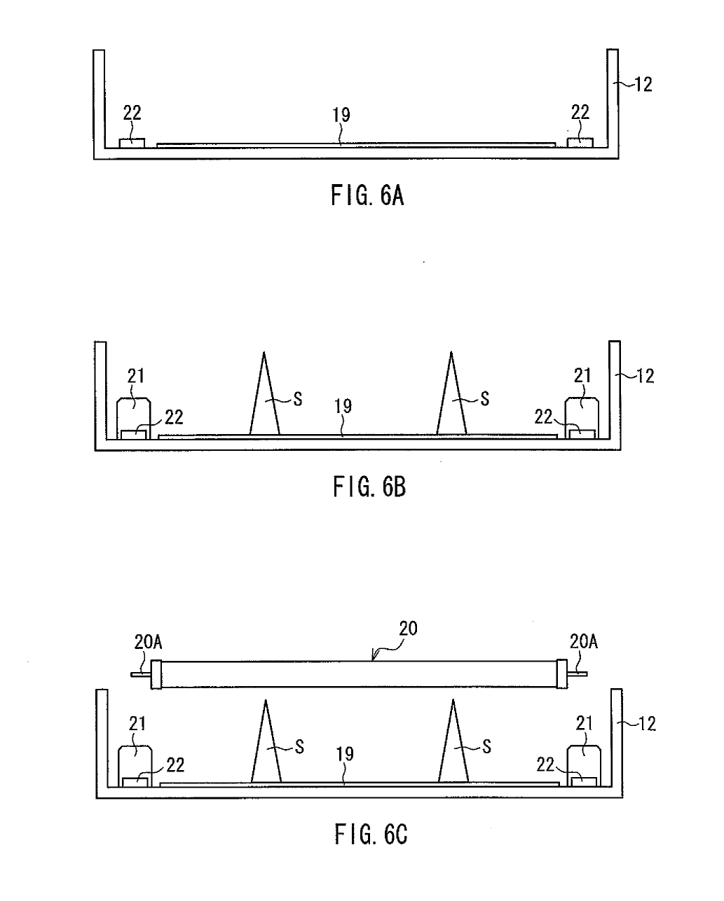

Here, a specific description will be given of a method for assembling the liquid crystal display device 1 of the present embodiment with reference to FIGS. 6A to 6C to 9.

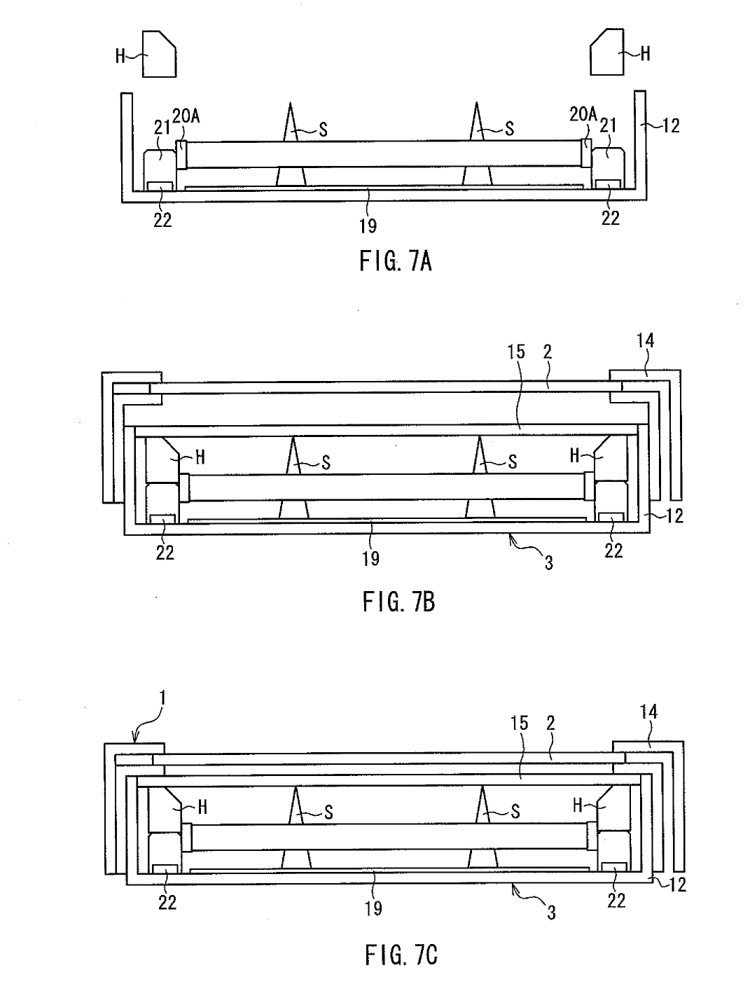

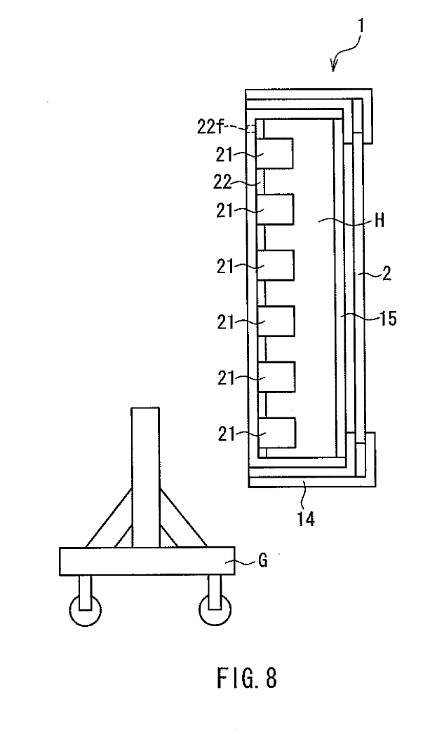

FIGS. 6A to 6C to 9 are views illustrating a process of assembling the liquid crystal display device. In FIGS. 7A to 7C and 8, the driver 9, the drive circuit 10, the optical sheet 17, and the like are not shown for the sake of simplicity.

First, as shown in FIGS. 6A to 6C, the illuminating device 3 of the present embodiment is assembled on a workbench not shown with the opening of the chassis 12 located upward. More specifically, as shown in FIG. 6A, the reflecting sheet 19 is placed on the inner surface of the chassis 12. Then, on the right and left end sides in the figure, the wiring members 22 to be both ends of the hot cathode fluorescent tube 20 in the longitudinal direction are located inside the chassis 12.

Then, as shown in FIG. 6B, the sockets 21 are fixed inside the chassis 12 while being connected electrically to the corresponding wiring members 22 at the both ends. Further, support members S for supporting the diffusion plate 15 are attached to the chassis 12.

Thereafter, as shown in FIG. 6C, the hot cathode fluorescent tube 20 is attached to the sockets 21. More specifically, the electrode terminals 20A1 and 20A2 (FIG. 3) of the hot cathode fluorescent tube 20 are inserted into the insertion holes 21a and 21b (FIG. 3) of the sockets 21, so that the hot cathode fluorescent tube 20 is connected electrically to the sockets 21 and the wiring members 22.

After that, as shown in FIG. 7A, the holders H are attached to the respective sockets 21 at the both ends. It should be noted that each of the right and left holders H is attached to the six sockets 21 so as to cover the sockets 21 and the wiring members 22 integrally.

Then, as shown in FIG. 7B, the diffusion plate 15 is provided on the holders H, and the optical sheet 17 not shown is arranged on the diffusion plate 15. Thus, the assembling operation of the illuminating device 3 is completed. Thereafter, the liquid crystal panel 2 and the bezel 14 are assembled with the illuminating device 3. Thus, as shown in FIG. 7C, the assembling operation of the main modules of the liquid crystal display device 1 on the workbench is completed.

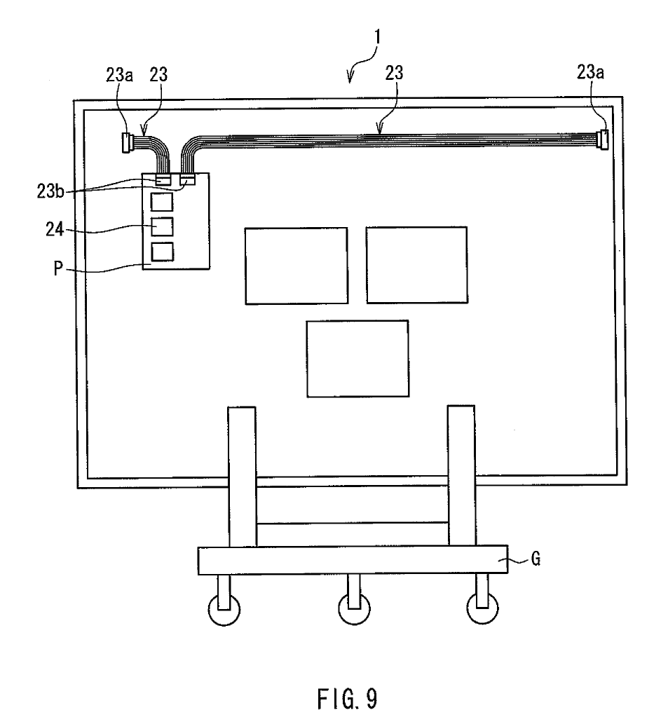

Next, as shown in FIG. 8, the main modules of the liquid crystal display device 1 shown in FIG. 7C are mounted on a movable base G. Then, as shown in FIG. 9, the wiring terminal portion 22f of the wiring member 22 led out to the outside (rear surface side) of the chassis 12 is connected with the terminal portion 23a provided on one end side of the multi-core cable 23. Further, a terminal portion 23b provided on the other end side of the multi-core cable 23 is connected to a printed board P mounted with the lighting drive circuit 24. As a result, each of the hot cathode fluorescent tubes 20 is connected electrically to the lighting drive circuit 24, and the wiring process of the hot cathode fluorescent tubes 20 with respect to the main modules of the liquid crystal display device 1 is completed. Thus, in the present embodiment, the wiring process on the rear surface side of the chassis 12 can be performed easily without turning down the chassis 12 so that the opening of the chassis 12 is located downward.

The illuminating device 3 of the present embodiment configured as described above includes the wiring member 22 that is connected electrically to the plurality of the sockets 21 so as to integrate the wirings of the plurality of the hot cathode fluorescent tubes (discharge tubes) 20. Thus, in the illuminating device 3 of the present embodiment, even when an increased number of the discharge tubes are provided, it is possible to eliminate the need for providing the wirings for the respective discharge tubes, unlike the conventional example. As a result, in the present embodiment, even when an increased number of the discharge tubes are provided, it is possible to provide the illuminating device 3 that can achieve a reduction in the number of components and improve the assembling operability.

More specifically, according to the conventional example, in the case of, for example, an illuminating device having twenty-four hot cathode fluorescent tubes, it is necessary to provide forty-eight wirings (cables) on each of the right and left sides and to perform the wiring process to connect these cables to the lighting drive circuit.

According to the present embodiment, on the other hand, regardless of the number of the hot cathode fluorescent tubes 20, the one wiring member 22 is provided on each of the right and left sides, and it is possible to perform the wiring process to connect a plurality of the hot cathode fluorescent tubes 20 to the lighting drive circuit 24 by means of the multi-core cable 23.

Further, in the illuminating device 3 of the present embodiment, since the wiring member 22 is provided so as to be movable with respect to the chassis (housing) 12, even when a thermal expansion difference develops between the wiring member 22 and the chassis 12, it is possible to prevent adverse effects on the wiring member 22 and the chassis 12 due to the thermal expansion difference. Namely, unlike the case where the wiring member 22 is fixed to the chassis 12, even when a thermal expansion difference develops between the wiring member 22 and the chassis 12 due to heat from the hot cathode fluorescent tubes 20, the thermal expansion difference between the wiring member 22 and the chassis 12 can be absorbed because of the wiring member 22 being relatively movable with respect to the chassis 12. As a result, it is possible to prevent adverse effects such as damage to the wiring member 22 and the chassis 12.

Further, in the illuminating device 3 of the present embodiment, since the wiring member 22 is formed of the printed circuit board, the wiring member 22 has an excellent handling property, and thus the assembling operation of the illuminating device 3 can be simplified easily.

Further, in the illuminating device 3 of the present embodiment, since the hot cathode fluorescent tubes 20 are used as discharge tubes, the discharge tubes (light sources) have excellent light conversion efficiency, and thus it is possible to provide the illuminating device 3 with excellent light emission efficiency easily.

Further, in the illuminating device 3 of the present embodiment, since the one multi-core cable 23 is used to connect the wiring member 22 and the lighting drive circuit 24 electrically, it is possible to provide easily the illuminating device 3 with a small number of components in which the wiring member 22 and the lighting drive circuit 24 can be connected easily.

Further, according to the present embodiment, even when an increased number of the discharge tubes are provided, the illuminating device 3 can achieve a reduction in the number of components and improve the assembling operability. Thus, it is possible to provide easily the liquid crystal display device 1 and the television receiver Tv that can be manufactured easily and can achieve an increase in screen size and brightness easily.

It should be noted that the above-described embodiment is illustrative and not limiting. The technical scope of the present invention is specified by the scope of the claims, and any modification falling in the scope of the configuration and equivalent described therein also fall in the technical scope of the present invention.

For example, although the above description explains the case where the present invention is applied to the transmission type liquid crystal display device, the illuminating device of the present invention is not limited thereto. The illuminating device of the present invention may be applied to various types of display devices each of which has a non-light-emitting type display portion for displaying information such as images and characters by utilizing light from a light source. More specifically, the illuminating device of the present invention can be applied suitably to a semi-transmission type liquid crystal display device or to a projection type display device in which a liquid crystal panel is used as a light bulb.

Further, besides the above description, the present invention can be used suitably as a film viewer irradiating light to a radiograph, a light box for irradiating light to a picture negative to make it easy to recognize the negative visually, and an illuminating device of a light-emitting device that lights up a signboard, an advertisement set on a wall surface in a station, or the like.

Further, the above description explains the configuration in which the sockets and the wiring member are arranged inside the chassis (housing), and the wirings of the hot cathode fluorescent tubes (discharge tubes) are led out of the chassis integrally by the wiring member. However, the present invention is not limited thereto, as long as it includes the sockets to be connected electrically to the respective electrode portions of a plurality of the discharge tubes, and the wiring member that is connected electrically to a plurality of the sockets to integrate the wirings of the plurality of the discharge tubes.

However, it is preferred that, as in the present embodiment, the sockets and the wiring member are connected electrically inside the housing, and the wirings of the plurality of the discharge tubes are led out to the outside of the housing integrally by the wiring member, as compared with the case where the sockets and the like are provided outside the housing. This is because the configuration of the present embodiment eliminates the need for operations of providing an attachment member and the like for attaching the sockets and the like outside the housing and attaching the sockets, and allows the illuminating device to have excellent assembling operability and a small number of components easily.

Further, although the above description explains the case where the hot cathode fluorescent tube is used, the discharge tube of the present invention is not limited thereto. Another discharge fluorescent tube such as a cold cathode fluorescent tube and a xenon fluorescent tube, or a non-straight-tube discharge fluorescent tube such as a U-shaped tube and a pseudo U-shaped tube may be used.

In the case of using a discharge fluorescent tube that does not contain mercury, such as a xenon fluorescent tube as described above, it is possible to provide a long-life illuminating device in which the discharge tubes are arranged in parallel with the direction of gravity.

Further, in the case of a so-called one-sided drive in which a discharge tube such as a cold cathode fluorescent tube and a pseudo U-shaped tube is supplied with power from one end side in the longitudinal direction thereof, the discharge tube and the lighting drive circuit are connected (wired) by using the above-described one wiring member.

### INDUSTRIAL APPLICABILITY

The present invention is useful for an illuminating device that can achieve a reduction in the number of components and improve the assembling operability even when an increased number of discharge tubes are provided, a display device using the same that can be manufactured easily, and a television receiver.

1. An illuminating device provided with a plurality of discharge tubes, the illuminating device comprising:
sockets to be connected electrically to respective electrode portions of the plurality of the discharge tubes; and
a wiring member that is connected electrically to a plurality of the sockets so as to integrate wirings of the plurality of the discharge tubes.

2. The illuminating device according to claim 1, wherein the wiring member and each of the plurality of the sockets are connected electrically so as to be movable with respect to each other.

3. The illuminating device according to claim 1, further comprising a housing that accommodates the plurality of the discharge tubes,
wherein the plurality of the sockets are provided inside the housing and are connected electrically with the plurality of the respective discharge tubes, and
the wiring member includes, inside the housing, socket connecting portions to be connected electrically to the plurality of the respective sockets and a wiring terminal portion for leading out the wirings of the plurality of the discharge tubes to the outside of the housing.

4. The illuminating device according to claim 3, wherein the wiring member is provided so as to be movable with respect to the housing.

5. The illuminating device according to claim 3, wherein each of the plurality of the sockets is fixed to the housing.

6. The illuminating device according to claim 1, wherein the wiring member includes a feedback signal line for performing feedback control of the discharge tubes.

7. The illuminating device according claim 1, wherein the wiring member includes ground wirings to be grounded.

8. The illuminating device according to claim 1, wherein in the wiring member, wiring portions to be connected to the respective electrode portions of the plurality of the discharge tubes are provided so as to be insulated from each other.

9. The illuminating device according to claim 1, wherein in the wiring member, a plurality of the socket connecting portions are provided linearly.

10. The illuminating device according to claim 1, wherein the wiring member is formed of a printed circuit board.

11. The illuminating device according to claim 1, wherein each of the discharge tubes is a hot cathode fluorescent tube.

12. The illuminating according to claim 1, further comprising a lighting drive circuit that lights the plurality of the discharge tubes,
wherein the wiring member and the lighting drive circuit are connected electrically to each other by using one multi-core cable having a plurality of core wires that are provided for the respective wirings of the plurality of the discharge tubes.

13. The illuminating device according to claim 1, wherein each of the sockets is fixed by a holder.

14. A display device using the illuminating device according to claim 1.

15. A television receiver provided with the display device according to claim 14.
